(19) United States
(12) Patent Application Publication
(10) Pub. No.: US 2018/0020840 A1
(43) Pub. Date: Jan. 25, 2018

(54) PORTABLE BED FOR OUTDOOR USE BY A PET THAT IS MOVEMENT-RESISTANT IN A TRUCK BED

(71) Applicant: Buddy James Auclair, Drayton Valley (CA)

(72) Inventor: Buddy James Auclair, Drayton Valley (CA)

(21) Appl. No.: 15/621,470

(22) Filed: Jun. 13, 2017

Related U.S. Application Data
(60) Provisional application No. 62/366,298, filed on Jul. 25, 2016.

(51) Int. Cl. A47C 17/80; A01K 1/015; A47C 31/10; B60N 3/00; A47C 31/00; A47C 17/64

(52) U.S. Cl. CPC A47C 17/80; A47C 31/003; A47C 17/645; A47C 31/105; B60N 3/008; A01K 1/015

(57) ABSTRACT

Described is a portable bed for outdoor use by a dog or other large pet which is movement-resistant when placed on a ferromagnetic surface such as a truck bed. The bed includes a durable removable outer cover suitable for exposure to inclement weather and an inner cushioning element received within the outer cover which may be a dog bed suitable for indoor use. At least a portion of the outer cover comprises a material producing a sufficiently strong magnetic field to impede or prevent the bed from shifting or otherwise moving on the ferromagnetic surface. This may prevent or at least measurably reduce shifting or other movement of the portable dog bed in a truck bed when the vehicle accelerates, breaks or turns. Alternatively, the portable bed may be configured for use as an insert in a dog crate with an optional top spill pad for convenient removal and cleaning.

### FIELD OF THE INVENTION

The present specification relates generally to accessories for pets such as dogs and more specifically relates to a portable bed for outdoor use in a truck bed.

### BACKGROUND OF THE INVENTION

Trucks owners who travel with their dogs often prefer to transport their dog in the bed of the truck. This may be to allow more room for human passengers, to avoid collecting hair or fur or drool in the vehicle's interior, or to prevent the dog from having the opportunity to interfere with the driver's operation of the vehicle. Dogs may also prefer the truck bed due to the additional space it allows them and as well as the fact it allows them to be outside, breathe outdoor air, and better experience sights and smells on the trip.

To increase comfort for a dog travelling in the bed of the truck, owners sometimes install a carpet, mat or other similar type of flooring in the bed of the truck. Other owners choose to put a dog bed on the truck bed for added comfort and softness. These dog beds and types of flooring are usually unsafe for dogs because the dog bed may move around substantially in the truck bed as the vehicles accelerates, stops or turns. These sudden shifts may result in injury to the dog should the dog, for example, collide with other cargo in the truck bed or the side of the truck bed. In extreme examples, the dog could even be thrown from the vehicle.

Moreover, should it be desirable to have a dog bed at your destination, the aforementioned items may not be readily removable and transportable or be particularly suitable for indoor use due to their prior exposure to outdoor elements including whatever outdoor elements the dog or other pet has been exposed to, such as mud. Transporting an indoor pet bed in the vehicle for use at the destination is a possibility, but it requires use of additional space.

Accordingly, there remains a need for improvements in the art.

### SUMMARY OF THE INVENTION

In accordance with an aspect of the invention, there is provided a portable bed for outdoor use by a pet that is shift-resistant in a truck bed.

According to an aspect of the invention, the present invention provides a portable bed for outdoor use by a pet which is movement-resistant when placed on a surface comprising ferromagnetic material, the bed comprising: an outer cover; and an inner cushioning element removably received within the outer cover; wherein at least a portion of the outer cover comprises a material producing a sufficiently strong magnetic field to impede the movement of the bed on the surface.

According to a further aspect of the invention, the present invention provides a removable outer cover for receiving an inner cushioning element to form a portable bed for a pet, wherein at least a portion of the outer cover comprises a material producing a sufficiently strong magnetic field to impede the movement of the bed when placed on a ferromagnetic surface.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a perspective view of an outer cover and an inner cushioning element which when combined form a portable bed for outdoor use by a pet according to an embodiment of the invention;

FIG. 2 is a perspective view of an inner cushioning element according to an embodiment of the invention;

FIG. 3 is a top view of portable bed for outdoor use in a truck bed according to an embodiment of the invention;

FIGS. 4A-4D are cross-sectional views of bottom panels of the outer cover showing the configurations of magnetic material according to embodiments of the invention;

FIG. 5 is a top view of a portable bed for outdoor use in a boat according to an embodiment of the invention;

FIG. 6 is a side view of a portable bed for outdoor use on a camper according to an embodiment of the invention; and

FIG. 7 is a perspective view of a portable bed for outdoor use in a dog crate according to an embodiment of the invention.

Like reference numerals indicated like or corresponding elements in the drawings.

### DETAILED DESCRIPTION OF THE EMBODIMENTS

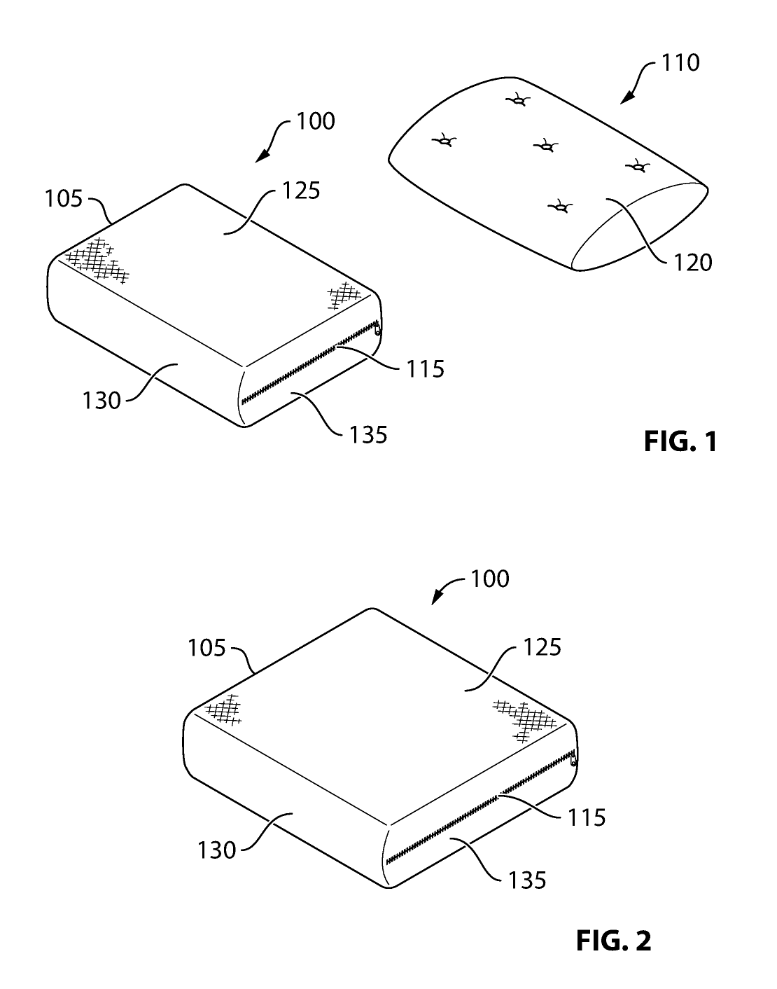

According to an embodiment as shown in FIGS. 1 and 2, a portable bed 100 for outdoor use by a pet is shown which may be movement-resistant when placed on a surface comprising ferromagnetic material. The bed 100 may comprise an outer cover 105 and an inner cushioning element 110. The inner cushioning element 110 may be removably received within the outer cover 105. At least a portion of the outer cover 105 may comprise a material that produces a sufficiently strong magnetic field to impede the movement of the bed 100 on the surface comprising ferromagnetic material. The inner cushioning element 110 is configured to provide comfort to the dog or other pet and may be configured to also be suitable for indoor use upon being removed from the outer cover 105.

According to an embodiment, a dog bed for indoor use inside one's home may be received as the inner cushioning element 110 within the outer cover 105 to form a portable bed 100 for a pet. As such, the present invention may comprise the outer cover 105, which then may be used with the dog owner's pre-existing dog bed as the inner cushioning element 110, or the present invention may comprise both an outer cover 105 and an inner cushioning element 110 which could, for example, be sold together in a system or kit.

The outer cover 105 may include a fastener, such as a zipper 115, to secure the inner cushioning element 110 within the outer cover 105. Other types of fasteners may be used as well or in place of a zipper such as hook and loop fasteners, buttons, snaps, and/or magnetic fasteners. Alternatively, an opening may be provided in the outer cover 105 for removable insertion of the cushioning element 110 and no fastener need be used. The outer cover 105 may also include one or more fasteners to secure the inner cushioning element 110 to the outer cover 105 (as opposed to within the outer cover 105) to restrain movement of the inner cushioning element 110 within the outer cover 105. This generally may not be needed where the outer cover 105 substantially conforms to the size and shape of the inner cushioning element 110. The one or more fasteners may be buttons, snaps, hooks or any other type of fastener known to a skilled person that may secure the inner cushioning element 110 to the outer cover 105.

Embodiment of the portable bed 100 may be made in varying shapes and sizes such that pets of varying sizes may fit comfortably. According to an embodiment, the bed 100 and the outer cover 105 may be greater than one and a half feet in length and greater than one and a half feet in width. Moreover, the bed 100 and the outer cover 105 may be substantially rectangular, oval, circular or any other shape that may comfortably fit pets of varying sizes.

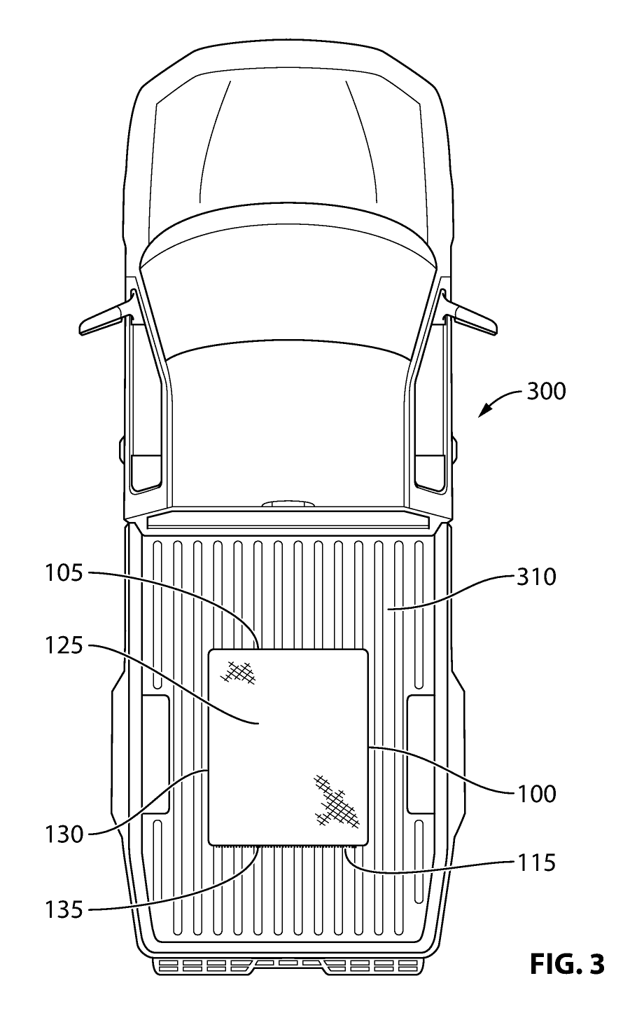

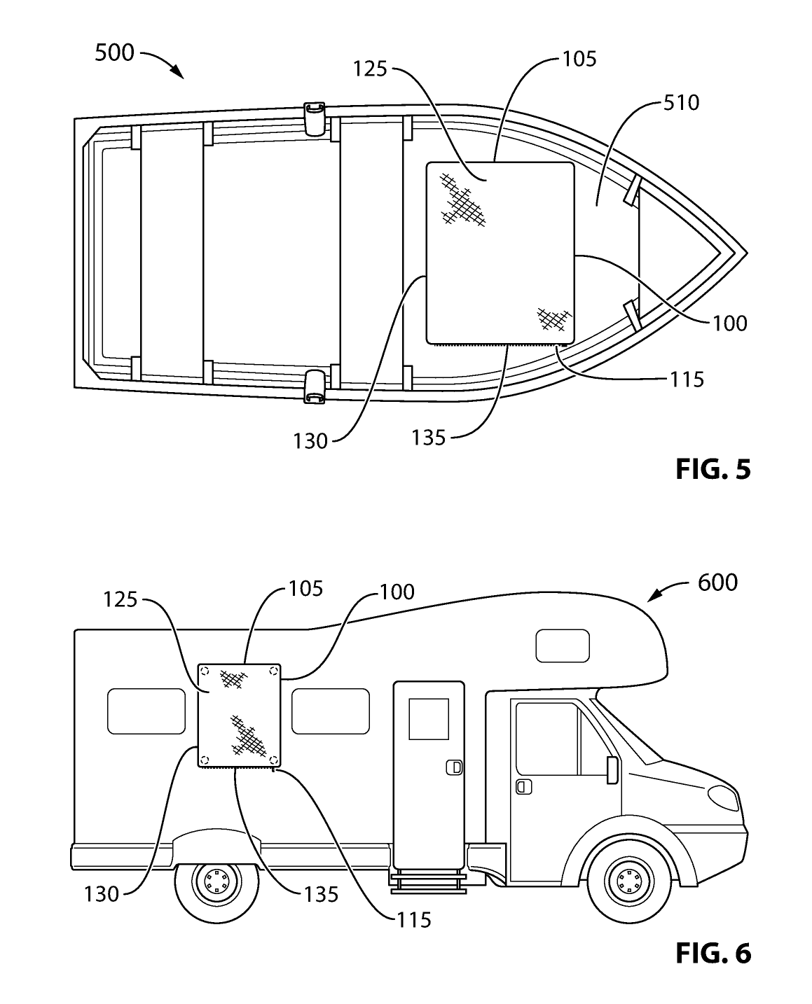

According to an embodiment as shown in FIG. 3, the surface comprising ferromagnetic material may be a truck bed 310 of a pick-up truck 300, wherein the portable bed 100 may be placed on the truck bed 310. The portable bed 100 may also include a securing means to secure the bed 100 to the truck bed 310, such as a chain with a lock, when the truck 300 is left unattended and the portable bed 100 could otherwise be removed from the truck bed 310 without the authorization of its owner. According to a further embodiment as shown in FIG. 5, the portable bed 100 may be placed on a bow 510 of a boat 500.

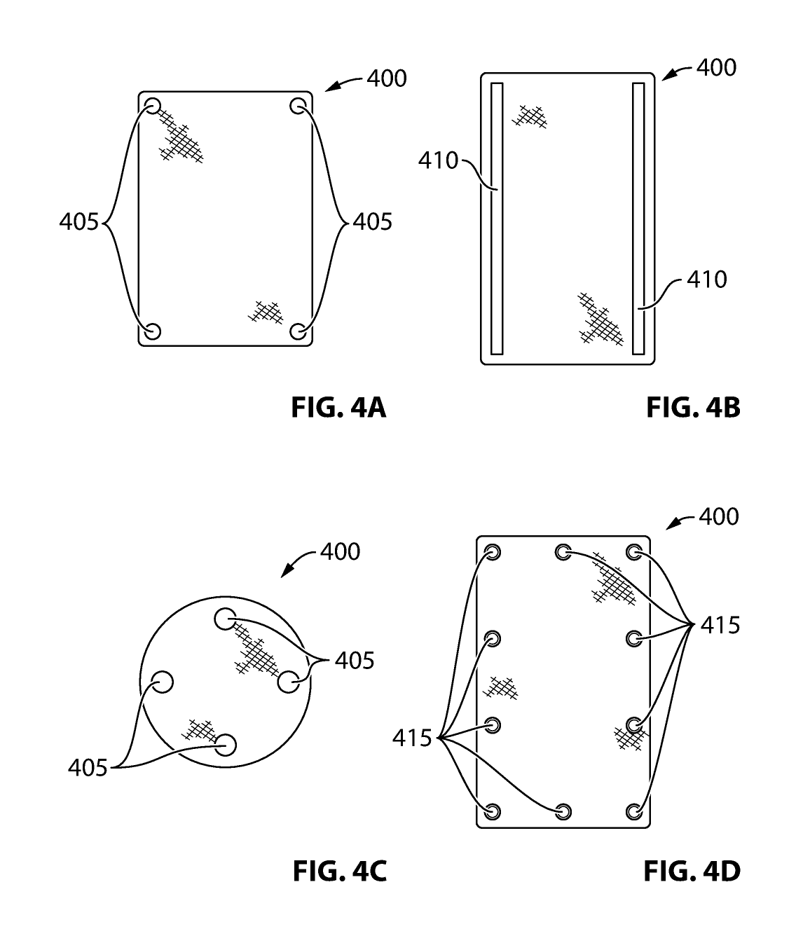

According to an embodiment as shown in FIG. 1, the outer cover 105 may comprise a top panel 125, a bottom panel 400 (as shown in FIG. 4), a left panel 130, a right panel (hidden in this view, but similar to the left panel), a front panel 135 and a back panel (hidden in this view, but similar to the front panel). At least a portion of the bottom panel 400 of the outer cover 105 may comprise a material that produces sufficiently strong magnetic field such as through employing magnetic fabric, discs, rings, sheets and/or strips. The magnetic material may be sewn into the bottom panel 400 of the bed 100 or otherwise manufactured to form part of the outer cover 105. The magnetic material may be of varying shapes and sizes, may be in varying numbers and may be placed in various configurations as long as a sufficiently strong magnetic field is produced taking in account the size of the bed 100 and the anticipated weight of the pet using the portable bed 100. However, the magnetic field generated should not be so strong as to prevent or make it difficult a human of normal strength from being able to remove the portable bed 100 off of the ferromagnetic surface.

By way of example, a few of the many possible configurations for the magnets are shown in FIG. 4. In FIG. 4A, a bottom panel 400 is shown with four magnetic discs 405 positioned at each corner of the bottom panel 400. In FIG. 4B, two magnetic strips 410 are shown positioned along the length of the bottom panel 400. In FIG. 4C, four magnetic discs 405 are shown positioned around the perimeter of the bottom panel 400. And in FIG. 4D, ten magnetic rings 415 are shown positioned around the perimeter of the bottom panel 400. A further configuration (not shown) is for the entire bottom panel to be in the form of a magnetic sheet that exhibits a relatively uniform magnetic field across the sheet. Moreover, according to various embodiments, it is possible for magnetic material to be placed on the outer surface of the bottom panel 400, the inner surface of the bottom panel 400 or within the bottom panel 400, as long as the magnets exert the necessary amount of magnetic force.

While the primary purpose of the magnets is to prevent or reduce movement of the bed 100 without human intervention, the magnetic material may also provide a benefit to pets laying on the bed 100 in the form of magnetic therapy. Magnetic therapy may provide relief for pets experiencing arthritic or rheumatic symptoms, for example.

The rest of the outer cover 105 may be made at least in part from a flexible material and additionally the inner cushioning element 110 may comprise an inner cover 120 which also may be made at least in part from flexible material so that both may be comfortable to the dog or other pet. Flexible material that may provide comfort to pets may include cotton, polyester, fleece, microsuede, wool or any other suitable material known to a skilled person that would provide comfort to pets. The outer cover 105 and the inner cover 120 may comprise an aesthetic design and other features such as pleats, gathers, ruffles, flutes, indentations, gathering, tucks, raised edges, etc., which may provide additional comfort to pets. The inner cushioning element 110 may be composed of material that may provide comfort to pets, such as foam, polyester, feather down, synthetic alternative down or any other suitable material known to a skilled person that would provide comfort to pets.

The outer cover 105 may be further made of a durable material and may also be water-resistant or waterproof, or weatherproof such that the inner cushioning element 110, and inner cover 120 if used, may be shielded from outdoor elements such as rain, snow, and hail. The outer cover 105 may also be ultraviolet light reflective to minimize the absorption of energy from sunlight and thereby reduce the extent that the bed 100 increases in temperature when exposed to the sun. Moreover, the use of the bed 100 itself may keep the dog cooler in the truck bed than having the dog in direct contact with the truck bed surface 310 which may get very hot in sunny weather. Further, the outer cover 105 may be anti-fungal and tear-resistant to provide longevity.

According to an embodiment as shown in FIG. 6, the magnetic material may provide a sufficiently strong magnetic field to prevent movement of the bed without human intervention when the bed is applied against a substantially vertical surface comprising ferromagnetic material such as the side of a camper 600, or the side of a truck or boat. This may make it easier to wash mud and other substances from the outer cover 105 and to dry the outer cover 105. The ability to, in effect, hang (via magnetic attraction to a substantially vertical surface including ferromagnetic material) the outer cover 105 or dog bed 100 vertically may also make the outer cover 105 or portable bed 100 easier to store and reduce or prevent mold build-up on the cover 105.

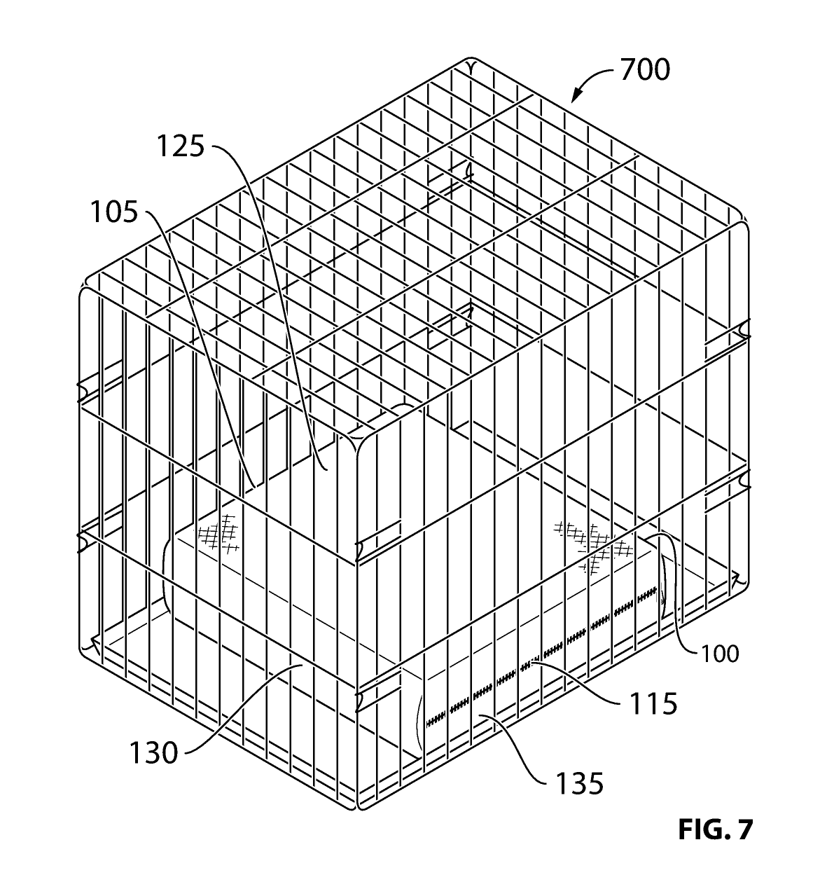

According to a further embodiment as shown in FIG. 7, the portable bed 100 may be used in dog crates such as dog crate 700. The portable bed 100 may magnetically connect to ferromagnetic material on the crate 700. The portable bed 100 may be removed from the crate 700 as needed for cleaning by hand or in a washing device such as a washing machine. According to an embodiment, a spill pad cover (not shown) may be attached to or placed on top of the portable bed 100 so that only the spill pad cover would be removed and cleaned should the dog urinate or defecate in the crate 700. The spill pad cover may be made of plastic and/or rubber or other spill-resistant material and may have a raised lip around the perimeter of the spill pad cover to retain spills.

Embodiments of the present invention as described herein may be suitable for use by hunters, sightseers, beach goers, boat travelers, campers, river attenders, outdoor adventurers, or anyone else who may bring their dogs or other pets with them in the back of a truck bed or camper.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A portable bed for outdoor use by a pet which is movement-resistant when placed on a surface comprising ferromagnetic material, the bed comprising:
an outer cover; and
an inner cushioning element removably received within the outer cover;
wherein at least a portion of the outer cover comprises a material producing a sufficiently strong magnetic field to impede the movement of the bed on the surface.

2. The bed of claim 1, wherein the outer cover is made at least in part from flexible material.

3. The bed of claim 1, wherein the outer cover is made of a durable material and shields the inner cushioning element from weather.

4. The bed of claim 1, wherein the inner cushioning element comprises an inner cover made at least in part from flexible material.

5. The bed of claim 1, wherein the bed is configured for use in a dog crate.

6. The bed of claim 5, wherein the bed further comprises a removable spill pad cover.

7. The bed of claim 1, wherein the outer cover includes a fastener securing the inner cushioning element within the outer cover.

8. The bed of claim 7, wherein the fastener is a zipper.

9. The bed of claim 1, wherein the inner cushioning element is configured for indoor use.

10. The bed of claim 8, wherein the inner cushioning element is an indoor dog bed.

11. The bed of claim 1, wherein the outer cover is shaped and sized to substantially conform to the shape of the inner cushioning element.

12. The bed of claim 1, wherein the sufficiently strong magnetic field to impede the movement of the bed on the surface is sufficiently strong to prevent movement of the bed without human intervention when the bed is applied against a substantially vertical surface comprising ferromagnetic material.

13. A removable outer cover for receiving an inner cushioning element to form a portable bed for a pet, wherein at least a portion of the outer cover comprises a material producing a sufficiently strong magnetic field to impede the movement of the bed when placed on a ferromagnetic surface.

14. The outer cover of claim 13, wherein the outer cover is made at least in part from flexible material.

15. The outer cover of claim 13, wherein the outer cover is made of a durable material and is waterproof

16. The outer cover of claim 13, wherein the outer cover is at least one and a half feet in length and at least one and a half feet in width.

17. The outer cover of claim 13, wherein the outer cover includes a fastener for securing the inner cushioning element within the outer cover.

18. The outer cover of claim 17, wherein the fastener is a zipper.

19. The outer cover of claim 13, wherein the outer claim is shaped and sized to substantially conform to the shape of the inner cushioning element.

20. The outer cover of claim 13, wherein the sufficiently strong magnetic field to impede the movement of the bed on the surface is sufficiently strong to prevent movement of the bed without human intervention when the bed is applied against a substantially vertical surface comprising ferromagnetic material.
